(19) United States
(12) Patent Application Publication
(10) Pub. No.: US 2003/0135570 A1
(43) Pub. Date: Jul. 17, 2003

(54) Method for sending electronic messages with attachments and eletronic device for sending such messages

(76) Inventor: Laurent Philippe Anquetil, Paris (FR)

Correspondence Address: SUGHRUE MION, PLLC, 2100 PENNSYLVANIA AVENUE, N.W., WASHINGTON, DC, 20037, US

(21) Appl. No.: 10/296,815

(22) PCT Filed: May 25, 2001
(86) PCT No.: PCT/FR01/01620

(30) Foreign Application Priority Data
May 29, 2000 (FR) 00/06840

(51) Int. Cl. G06F 15/16

(52) U.S. Cl. 709/206

(57) ABSTRACT

The invention relates to a method of sending electronic messages with attachments, the method including a step of indicating an addressee to receive the message and its attachment. The method is characterized in that it includes a step of indicating an addressee having to receive the message without its attachment. The invention also relates to a device for implementing the method.

The present invention relates to a method of sending electronic messages with attachments and to an electronic device for sending such messages. It is known in the art that electronic messages can have attachments in the form of digital files which are sent to their addressees at the same time as the messages proper.

It is also known in the art that the ease with which attachments can be sent is one cause of the very large increase in the volume of electronic mail exchanged daily, especially as the majority of messages have a list of addressees rather than a single addressee.

At present there are only two categories of addressee, namely direct addressees and copy addressees, but this distinction is purely formal because the message transmitted is the same in each case, with the result that the total number of addressees of the message, i.e. those designated as direct addressees and those designated as copy addressees, constitutes a multiplier coefficient that transforms the original message into as many messages to be transmitted by the mail server.

Also, for addressees to whom the widely broadcast message is of little interest, reception of the message and its attachments, which are often large, takes up room unnecessarily in the space reserved for received messages in their receiver device.

The present invention aims to provide a simple solution to the problems outlined above.

The present invention provides a method of sending electronic messages with attachments, the method including a step of indicating an addressee to receive the message and its attachment, and the method being characterized in that it further includes a step of indicating an addressee to receive the message without its attachment.

In other words, the invention designates mere message copy addressees who are distinguished from the usual addressees, who are full copy addressees.

One particular embodiment of the invention, in which an electronic message is structured with a series of headers and each header is specific to a property of the message, is characterized in that a specific header is reserved for a list of addressees to receive the message and its attachment and another specific header is reserved for a list of addressees to receive the message without its attachment.

This embodiment can in particular be based on the syntax of the RFC 822 standard and the extension field or the defined user's field specified therein.

The RFC 822 standard is defined by the Internet Engineering Task Force (IETF).

The present invention further provides an electronic device for sending electronic messages with attachments, the device including entry means for specifying an addressee of said message and its attachment, and the device being characterized in that it further includes entry means for specifying an addressee of the message without its attachment.

In one particular embodiment of the invention the electronic device includes entry means for specifying a message to be sent and entry means for specifying an attachment to the message.

In one particular variant the device includes means for generating a specific message header from information from each entry means.

The invention can be implemented by an electronic device with an appropriate hardware or software configuration.

In particular, the invention can be implemented by a computer program for sending electronic messages and including a series of input instructions for indicating an addressee to whom the message and its attachment must be sent, which program is characterized in that it further includes a series of input instructions for indicating an addressee of the message without its attachment.

In one particular embodiment, the computer program can include a series of input instructions for entering a message to be sent and a series of input instructions for attaching at least one digital file to the message. A variant of the computer program can include a series of output instructions for generating a message header specific to each item of information obtained by executing each series of input instructions.

It must be understood that the above description is in no way limiting on the scope of the invention and that modified features that are not described as essential in the above description remain within the scope of the claims.

1. A method of sending electronic messages with attachments, the method including a step of indicating an addressee to receive the message and its attachment, and the method being characterized in that it further includes a step of indicating an addressee to receive the message without its attachment.

2. A method according to claim 1, wherein an electronic message is structured with a series of headers and each header is specific to a property of the message, which method is characterized in that a specific header is reserved for a list of addressees to receive the message and its attachment and another specific header is reserved for a list of addressees to receive the message without its attachment.

3. An electronic device for sending electronic messages with attachments, the device including entry means for indicating an addressee of said message and its attachment, and the device being characterized in that it further includes entry means for indicating an addressee of the message without its attachment.

4. An electronic device according to claim 3, characterized in that it includes entry means for specifying a message to be sent and entry means for specifying an attachment to the message.

5. A device according to claim 3 or claim 4, characterized in that it includes means for generating a specific message header from information from each entry means.
